(19) United States
(12) Patent Application Publication
(10) Pub. No.: US 2026/0144307 A1
(43) Pub. Date: May 28, 2026

(54) AEROSOL PROVISION DEVICE

(71) Applicant: Nicoventures Trading Limited, London (GB)

(72) Inventors: Tom WOODMAN, London (GB); Richard HEPWORTH, London (GB)

(21) Appl. No.: 19/122,775

(22) PCT Filed: Oct. 17, 2023
(86) PCT No.: PCT/EP2023/078867

§ 371 Date: Apr. 21, 2025

(30) Foreign Application Priority Data
Oct. 21, 2022 (GB) 2215593.1

(51) Int. Cl. A24F 40/57; A24F 40/46; A24F 40/465; A24F 40/51; A24F 40/53; A24F 40/60; H05B 3/22; H05B 6/10

(52) U.S. Cl. CPC A24F 40/57; A24F 40/46; A24F 40/465; A24F 40/51; A24F 40/53; A24F 40/60; H05B 3/22; H05B 6/108

(57) ABSTRACT

An aerosol provision device for generating an aerosol from an article comprising aerosol generating material, the aerosol provision device comprising: an aerosol generator comprising an internal heating arrangement and an external heating arrangement; and a controller, wherein at least a portion of the internal heating arrangement is arranged to extend into the article to heat the aerosol generating material and at least a portion of the external heating arrangement is arranged to extend at least partly around the article to heat the aerosol generating material, wherein the controller is configured to: receive a pre-inhale signal indicating that an inhale from the aerosol provision device is imminent; and in response to receiving the pre-inhale signal, control one of the internal heating arrangement and the external heating arrangement to begin heating.

### CROSS-REFERENCE TO RELATED APPLICATIONS

This present application is a National Phase entry of PCT Application No. PCT/EP2023/078867, filed Oct. 17, 2023, which claims priority from Great Britian Application No. 2215593.1, filed Oct. 21, 2022, each of which are fully incorporated herein by reference in their entireties.

### TECHNICAL FIELD

The present invention relates to an aerosol provision device, an aerosol provision system and a method of operating an aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device for generating an aerosol from an article comprising aerosol generating material, the aerosol provision device comprising: an aerosol generator comprising an internal heating arrangement and an external heating arrangement; and a controller, wherein at least a portion of the internal heating arrangement is arranged to extend into the article to heat the aerosol generating material and at least a portion the external heating arrangement is arranged to extend at least partly around the article to heat the aerosol generating material, wherein the controller is configured to: receive a pre-inhale signal indicating that an inhale from the aerosol provision device is imminent; and in response to receiving the pre-inhale signal, control one of the internal heating arrangement and the external heating arrangement to begin heating.

The aerosol provision device may comprise a pre-inhale detection element, the pre-inhale detection element configured to: determine that the inhale from the aerosol provision device is imminent; and in response to determining that the inhale from the aerosol provision device is imminent, send the pre-inhale signal to the controller.

The pre-inhale detection element may comprise a user controllable element, the user controllable element configured to receive an input from a user to indicate that the inhale from the aerosol provision device is imminent.

The pre-inhale detection element may comprise a movement sensor, the movement sensor configured to sense a movement and/or a position of the aerosol provision device to determine that the inhale from the aerosol provision device is imminent.

The movement may be a rotation of the aerosol provision device.

The pre-inhale detection element may comprise a touch sensor, the touch sensor configured to sense the user touching a portion of the aerosol provision device to determine that the inhale from the aerosol provision device is imminent.

The controller may be configured to: receive an in progress inhale signal indicating that the user is drawing air from the aerosol provision device; and in response to receiving the in progress inhale signal, control the other of the internal heating arrangement and the external heating arrangement to begin heating. E.g. the other of the internal arrangement and the external arrangement is the one not already controlled to begin heating in response to the pre-inhale signal.

The aerosol provision device may comprise an in progress inhale detection element, the in progress inhale detection element configured to: detect a user drawing air from the aerosol provision device; and in response to detecting the user drawing air from the aerosol provision device, send the in progress inhale signal to the controller.

The controller may be configured to control the first heating arrangement to continue heating after receiving the in progress inhale signal.

The first heating arrangement may be the external heating arrangement.

The first heating arrangement may be the internal heating arrangement.

The internal heating arrangement may comprise an elongate heating element.

The elongate heating element may have a diameter of at least 3 mm, e.g. at least 5 mm, e.g. at least 6 mm. The elongate heating element may have a diameter of less than 12 mm, e.g. less than 10 mm, e.g. less than 8 mm, e.g. approximately 7 mm.

The external heating arrangement may comprise a tubular body. The external heating arrangement may comprise an external heating element configured to heat inside the tubular body. The external heating element may be positioned on an inner surface of the tubular body. The external heating element may have an inner diameter of at least 5 mm. The external heating element may have an inner diameter of less than 15 mm.

The external heating arrangement may be configured to fully encircle the aerosol generating article.

The internal heating arrangement may comprise a plurality of internal heating elements axially displaced along a length of the first heating arrangement.

The external heating arrangement may comprise a plurality of external heating elements axially displaced along a length of the second heating element.

At least one of the external heating elements may be axially aligned with a respective internal heating element. Each of a plurality of the external heating elements may be axially aligned with a respective internal heating element. Each of the external heating elements may be axially aligned with a respective internal heating element.

The internal heating arrangement may comprise a resistive heating arrangement. The external heating arrangement may comprise a resistive heating arrangement. The internal heating arrangement may comprise an inductive heating arrangement. The external heating arrangement may comprise an inductive heating arrangement. The internal and external heating arrangements may comprise resistive and/or inductive heating arrangements in any combination.

The aerosol provision device may comprise a housing which houses at least one electrical component of the device. The internal heating arrangement and/or the external heating arrangement may extend from the housing. The internal heating arrangement and/or the external heating arrangement may comprise a portion not surrounded by the housing. The internal heating arrangement and/or the external heating arrangement may not be surrounded by the housing along substantially the length of the internal heating arrangement and/or the external heating arrangement.

In accordance with some embodiments described herein, there is provided an aerosol provision system comprising the aerosol provision device described above and an article comprising aerosol generating material. The aerosol provision device of the system may comprise one or more, or all, of the features described above, as appropriate.

In accordance with some embodiments described herein, there is provided a method of operating an aerosol provision device for generating an aerosol from an article comprising aerosol generating material, the aerosol provision device comprising an internal heating arrangement and an external heating arrangement, wherein at least a portion of the internal heating arrangement is arranged to extend into the article to heat the aerosol generating material and at least a portion of the external heating arrangement is arranged to at least partly extend around the article to heat the aerosol generating material, the method comprising: receiving a pre-inhale signal indicating that a user is about to draw from the aerosol provision device; and in response to receiving the pre-inhale signal, control one of the internal heating arrangement and the external heating arrangement to begin heating.

The aerosol provision device of the method may comprise one or more, or all, of the features described above, as appropriate. The method may comprise any of the functional steps described above with respect to the aerosol provision system, the aerosol provision device and the article.

### BRIEF DESCRIPTION OF THE DRAWINGS

Embodiments will now be described, by way of example only, and with reference to the accompanying drawings in which:

FIG. 1 shows a cross-sectional side view of an aerosol provision device and an article;

FIG. 2 shows a cross-sectional side view of an aerosol provision system;

FIG. 3 shows a cross-sectional side view of an aerosol provision device; and

FIG. 4 shows a method of operating an aerosol provision device.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavourants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50wt %, 60wt % or 70wt % of amorphous solid, to about 90wt %, 95wt % or 100wt % of amorphous solid.

The aerosol-generating material may comprise an aerosol-generating film. The aerosol-generating film may comprise or be a sheet, which may optionally be shredded to form a shredded sheet. The sheet may be a crimped sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and an article, typically a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilise the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

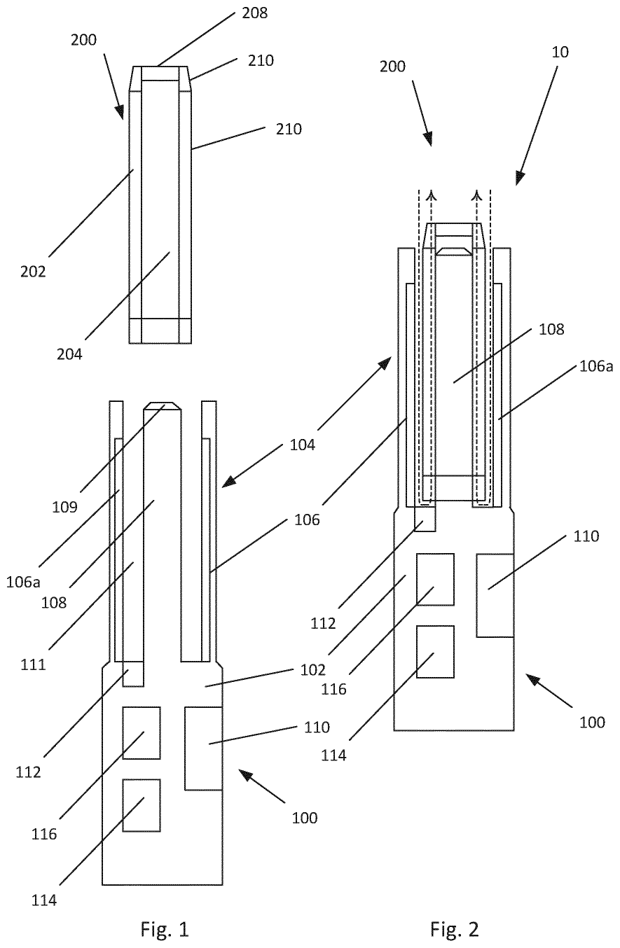

With reference to FIG. 1 and FIG. 2, an aerosol provision system 10 comprises an aerosol provision device 100 for generating aerosol from an aerosol generating material. The aerosol provision system 10 further comprises a replaceable article 200 comprising the aerosol generating material. In broad outline, the aerosol provision device 100 may be used to heat the article 200 to generate an aerosol or other inhalable medium, which is inhaled by a user of the device 100. Though FIG. 1 and FIG. 2 show the same aerosol provision device 100 and article 200, several reference numerals are omitted from FIG. 1 or FIG. 2 for clarity.

The aerosol provision device 100 comprises a housing 102. The housing 102 houses various components of the aerosol provision device 102.

The aerosol provision device 100 comprises an aerosol generator 104. The aerosol generator 104 comprises an internal heating arrangement 108. The aerosol generator 104 comprises an external heating arrangement 106. The internal heating arrangement 108 is configured to be received inside the article 200. The external heating arrangement 106 is configured to receive the article 200 inside it.

The internal heating arrangement 108 is elongate. The internal heating arrangement 108 is substantially cylindrical. The internal heating arrangement 108 comprises a short, frustoconical end portion 109, such that the internal heating arrangement tapers at a distal end. The internal heating arrangement 108 has a diameter of approximately 7 mm. The internal heating arrangement comprises a resistive heating element (not shown in the figures).

The internal heating arrangement 108 extends away from the housing 102. The internal heating arrangement 108 is not surrounded by the housing 102.

The external heating arrangement 106 is a tubular body 106. The external heating arrangement 106 has a circular cross-section. The external heating arrangement 106 comprises an inductive element 106a The inductive element is configured to produce a varying magnetic field. The inductive element 106a is a coil 106a.

Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

In other examples, the external heating arrangement 106 comprises a resistive heating element. The external heating arrangement 106 may comprise an insulating element to reduce heat transfer to the outside of the external heating arrangement 106.

The external heating arrangement 106 extends away from the housing 102. In the present example, the external heating arrangement 106 is not surrounded by the housing 102. The external heating arrangement may have a housing distinct from the housing 102. In other examples, the external heating arrangement 106 is covered by the housing 102.

An article receptacle 111 is formed between the internal heating arrangement 108 and the external heating arrangement 106. The article receptacle 111 has an annular shape.

The aerosol provision device 100 comprises a pre-inhale detection element 110. The pre-inhale detection element 110 is in the housing 102. The pre-inhale detection element 110 is a touch sensor 110. The touch sensor 110 is a capacitive touch sensor. The touch sensor 110 is configured to sense a user touching the touch sensor 110. The touch sensor 110 forms a part of the outer surface of the housing 102.

The aerosol provision device 100 comprises an in progress inhale detection element 112. The in progress inhale detection element 112 is in the housing 102. The in progress inhale detection element 112 is a pressure sensor 112. The pressure sensor 112 is configured to detect a pressure drop in the article receptacle 111. The pressure sensor 112 is a differential pressure sensor configured to detect a difference in pressure between the article receptacle 111 and the housing 102.

The aerosol provision device 100 comprises a power source 114 for supplying power to the aerosol generator 104. The aerosol provision device 100 comprises a controller 116. The power source 114 is in the housing 102. The controller 116 is in the housing 102. The power source supplies electrical power to the aerosol generator, and the aerosol generator converts the supplied electrical energy into heat energy for heating the aerosol-generating material. The power source may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source is electrically coupled to the aerosol generating assembly to supply electrical power when required and under control of a controller (not shown) to heat the aerosol generating material. The controller may be configured to activate and deactivate the aerosol generating assembly based on a user input. The controller is housing in the housing The article 200 comprises aerosol generating material 202. The article 200 comprises a cavity 204. The cavity 204 is cylindrical. The aerosol generating material 202 is tubular. The aerosol generating material 202 surrounds the cavity 204. The article 200 comprises a mouth end 208. The mouth end 208 is received in the user's mouth in use. The article 200 comprises a filter element 210. The filter element 210 is at the mouth end 208. The article 200 comprises an outer surface 212. The outer surface 212 is formed from paper. The aerosol generating material 202 comprises a susceptor material (not shown) embedded therein, for example, distributed throughout the aerosol generating material 202. In other examples, the susceptor material surrounds the aerosol generating material 202, for example, being comprised in the external heating arrangement and/or adjacent to an externally located inductor coil of the external heating arrangement. In other examples, the susceptor material is formed in a component that extends into the aerosol generating material, for example, being comprised in the internal heating arrangement and/or adjacent to an internally located coil of the internal heating arrangement.

In use, the article 200 is received in the article receptacle 111, as shown in FIG. 2. The internal heating arrangement 106 extends into the article 200. The external heating arrangement 108 extends around the article 200.

An inlet flow path 118 to the article 200 permits air to flow from outside the aerosol provision system 10 to the article 200. The inlet flow path 118 is between the external heating arrangement 106 and the article 200. The inlet flow path 118 is defined by an annular volume. In other examples, air flows from an air inlet (e.g. an aperture) at the base of the article receptacle 111.

The pre-inhale detection element 110 determines that an inhale from the aerosol provision device 100 is imminent. More specifically, the touch sensor 110 determines that a user is touching the aerosol provision device 100 to determine that an inhale from the aerosol provision device is imminent.

In response to determining that an inhale from the aerosol provision device 100 is imminent, the pre-inhale detection element 110 sends a pre-inhale signal to the controller 116.

In response to receiving the pre-inhale signal, the controller controls a first heating arrangement of the internal heating arrangement 108 and the external heating arrangement 106 to begin heating (i.e. one of the heating arrangements) the aerosol generating material 202. This may permit the aerosol generating material 202 to reach its operating temperature more quickly when an inhale subsequently begins. In response to receiving the pre-inhale signal, the controller 116 does not control a second heating arrangement of the internal heating arrangement 108 and the external heating arrangement 106 (i.e. the one other than the first) to begin heating.

The first of the internal heating arrangement 108 and the external heating arrangement 106 comprises a resistive heating element. In the present example, the first heating arrangement of the internal heating arrangement 108 and the external heating arrangement 106 is the internal heating arrangement 108. In other examples, pre-heating may be performed by the external heating arrangement and/or a heating arrangement comprising an inductive element.

When a user inhales on the article 200, air flows between the external heating arrangement 106 and the article 200, through the inlet flow path 118. The air enters the article 200 through a device end (opposite to the mouth end 208) of the article 200. The air is drawn through the aerosol generating material 202, past the internal heating arrangement 108, exiting the mouth end 208 to be inhaled by the user.

The in progress inhale detection element 112 detects that a user is drawing air from the aerosol provision device 100. The pressure sensor 112 determines a pressure drop in the inlet flow path 118 to detect that a user is drawing air from the aerosol provision device 100.

In response to detecting that a user is drawing air from the aerosol provision device 100, the in progress inhale detection element 112 sends an in progress inhale signal to the controller 116. In response to receiving the in progress inhale signal, the controller 116 controls a second heating arrangement of the internal heating arrangement 108 and the external heating arrangement 106 to begin heating the aerosol generating material 202. The second heating arrangement is a different heating arrangement from the first heating arrangement i.e. is the other heating arrangement than that which is used for pre-heating. In response to receiving the in progress inhale signal, the controller 116 controls the first heating arrangement to continue heating.

The in progress inhale detection element 112 continues to detect the user drawing air from the aerosol provision device 100 after sending the in progress inhale signal. The in progress inhale detection element 112 periodically detects whether a user is drawing air from the aerosol provision device 100.

In response to detecting that the user is not drawing air from the aerosol provision device 100, the in progress inhale detection element 112 sends an inhale stopped signal to the controller 116. In response to receiving the inhale stopped signal, the controller 116 controls the first and second heating arrangements to stop heating.

In other examples, in response to receiving the inhale stopped signal, the controller 116 controls the first heating arrangement to continue heating until a no pre-inhale signal is sent from the pre-inhale detection element 110. The pre-inhale detection element 110 sends a no pre-inhale signal to the controller 116 in response to determining that an inhale from the aerosol provision device is not imminent, for example, due to the user no longer touching the touch sensor 110. By continuing to heat via the first heating arrangement, the aerosol generating material 202 is preheated for an additional inhale.

In response to receiving the pre-inhale signal but not receiving the inhale in progress signal within a time period (e.g. 5 s) of receiving the pre-inhale signal, the controller 116 controls the first heating arrangement to stop heating.

In other examples, the pre-inhale detection element is configured to continue determining that the inhale from the aerosol provision device is imminent after sending the pre-inhale signal, and, in response to determining that the inhale is no longer imminent (e.g. due to the user no longer touching the touch sensor 110), send a no pre-inhale signal to the controller. The controller then controls the first heating arrangement to stop heating.

In the present example, the controller is configured to control the aerosol generator 104 to generate aerosol from the article 200 during an aerosol generating session. The aerosol generating session defines a time period in which the user may make multiple inhales on the aerosol provision device 100. The aerosol generating session begins when a user provides an input to a first user controllable element (not shown in FIGS. 1 and 2, e.g. a button). The pre-inhale detection element determines whether an inhale from the aerosol provision device is imminent only during the aerosol generating session. The controller 116 may control the internal and/or external heating arrangements to heat during the aerosol generation session at times other than when the pre-inhale signal and/or the in progress inhale detection signals are received, for example, to maintain the aerosol generating material 202 at lower temperature than is required during an inhale. In such examples, in response to receiving the pre-inhale signal, the controller 116 may control the internal and/or external heating arrangements to heat to a higher temperature and/or for a longer time period than if the signal had not been received. In other examples, no heating takes place at times other than when the pre-inhale signal and/or the in progress inhale detection signals are received.

In other examples, the aerosol provision device may comprise a plurality different types of pre-inhale detection elements (e.g. multiple touch sensors or a touch sensor and movement/position sensor), with pre-heating occurring in response to a plurality of pre-inhale detection elements indicating that an inhale from the aerosol provision device is imminent.

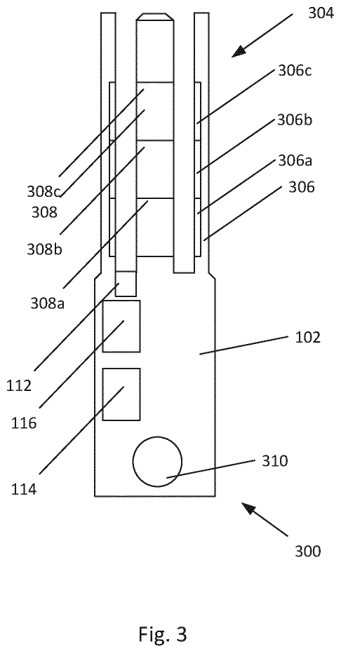

With reference to FIG. 3, a second aerosol provision device 300 comprises a second aerosol generator 304. The second aerosol provision device 300 comprises many features which are substantially the same as those of the aerosol provision device 100, for which the same reference numerals are used in FIG. 3 and FIGS. 1 & 2. In the following description of the second aerosol provision device 300, differences between second aerosol provision device 300 and the aerosol provision device 100 are described and repeated description of features common the system is omitted.

The second aerosol generator 304 comprises a second internal heating arrangement 308 and a second external heating arrangement 306.

The second internal heating arrangement 308 comprises a plurality of internal heating elements 308a-c. The second internal heating arrangement 308 comprises a first internal heating element 308a, a second internal heating element 308b and a third internal heating element 308c. The internal heating elements 308a are axially displaced along the length of the second internal heating arrangement 308.

The second external heating arrangement 306 comprises a plurality of external heating elements 306a-c. The second external heating arrangement 306 comprises a first external heating element 306a, a second external heating element 308b and a third external heating element 306c. The external heating elements 306a are axially displaced along the length of the second external heating arrangement 306.

The first internal heating element 308a is axially aligned with the first internal heating element 306a. The second internal heating element 308b is axially aligned with the second internal heating element 306b. The third internal heating element 308c is axially aligned with the third internal heating element 306c.

The second aerosol provision device 300 comprises a second pre-inhale detection element 310. The second pre-inhale detection element is a second user controllable element 310. In use, the second user controllable element 310 receives an input from a user to indicate that an inhale from the aerosol provision device 300 is imminent. In response to receiving the input, the second user controllable element 310 sends the pre-inhale signal to the controller 116.

The internal heating elements 308a-c are heated sequentially. The internal heating elements 308a-c heat different portions of the aerosol generating material 202. The external heating elements 306a-c are heated sequentially. The external heating elements 306a-c heat different portions of the aerosol generating material 202. The different portions are displaced longitudinally along the aerosol generating material 202.

Each external heating element 306a-c is coordinated to operate with a respective internal heating element 308a-c. During a first inhale, the controller 116 controls the first internal heating element 308a and the first external heating element 306a to heat a first portion of the aerosol generating material 202. During a second inhale, the controller 116 controls the second internal heating element 308b and the second external heating element 306b to heat a second portion of the aerosol generating material 202. During a third inhale, the controller 116 controls the third internal heating element 308c and the third external heating element 306c to heat a first portion of the aerosol generating material 202.

In response to receiving the pre-inhale signal, the controller 116 controls one of the heating elements to begin heating. Apart from the differences mentioned here, the second aerosol provision device 300 operates in the same way as the aerosol provision device 100.

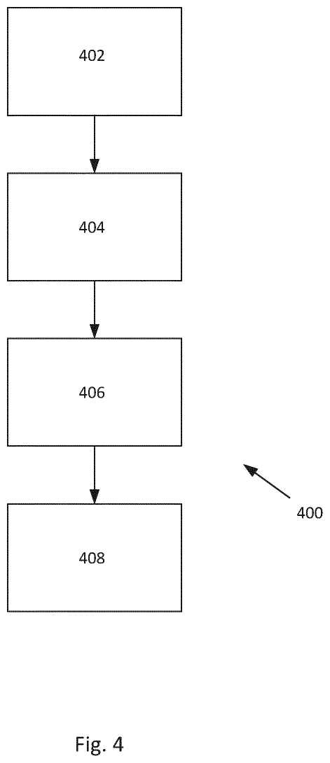

With reference to FIG. 4, a method 400 comprises a pre-inhale detection step 402, a pre-heating step 404, an in progress inhale detection step 406 and a heating step 408.

In the pre-heating step 402, a pre-inhale signal indicating that a user is about to draw from the aerosol provision device is received.

In the pre-heating step 404, a first of an internal heating arrangement and an external heating arrangement begins heating.

In the in progress inhale detection step 406, an in progress inhale signal indicating that a user is drawing on an aerosol provision device is received.

In the heating step, a second of the internal heating arrangement and the external heating arrangement beings heating.

The method 300 may be performed by the aerosol provision device 100 and/or the second aerosol provision device 200. The method 300 may further comprise any of the functional steps described above with respect to the aerosol provision device 100 and/or the second aerosol provision device 200.

In the above described embodiments, internal heating arrangement is configured for resistive heating and the external heating arrangement is for inductive heating. In other examples, the internal heating arrangement is configured for inductive heating and the external heating arrangement is for resistive heating.

In other examples, the internal and external heating arrangements may both be configured for inductive heating. The internal and external heating arrangements may both heat the same susceptor component.

In other examples, the internal and external heating arrangements may both be configured for resistive heating.

In resistive heating arrangements the aerosol generating assembly comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device for generating an aerosol from an article comprising aerosol generating material, the aerosol provision device comprising:
an aerosol generator comprising an internal heating arrangement and an external heating arrangement; and
a controller,
wherein at least a portion of the internal heating arrangement is arranged to extend into the article to heat the aerosol generating material and at least a portion of the external heating arrangement is arranged to extend at least partly around the article to heat the aerosol generating material,
wherein the controller is configured to:
receive a pre-inhale signal indicating that an inhale from the aerosol provision device is imminent; and
in response to receiving the pre-inhale signal, control one of the internal heating arrangement and the external heating arrangement to begin heating.

2. The aerosol provision device according to claim 1 and comprising a pre-inhale detection element, the pre-inhale detection element configured to:
determine that the inhale from the aerosol provision device is imminent; and
in response to determining that the inhale from the aerosol provision device is imminent, send the pre-inhale signal to the controller.

3. The aerosol provision device according to claim 2, wherein the pre-inhale detection element comprises a user controllable element, the user controllable element configured to receive an input from a user to indicate that the inhale from the aerosol provision device is imminent.

4. The aerosol provision device according to claim 2, wherein the pre-inhale detection element comprises a movement sensor, the movement sensor configured to sense a movement and/or a position of the aerosol provision device to determine that the inhale from the aerosol provision device is imminent.

5. The aerosol provision device according to claim 4, wherein the movement is a rotation of the aerosol provision device.

6. The aerosol provision device according to claim 2, wherein the pre-inhale detection element comprises a touch sensor, the touch sensor configured to sense the user touching a portion of the aerosol provision device to determine that the inhale from the aerosol provision device is imminent.

7. The aerosol provision device according to claim 1, wherein the controller is configured to:
receive an in progress inhale signal indicating that the user is drawing air from the aerosol provision device; and
in response to receiving the in progress inhale signal, control the other of the internal heating arrangement and the external heating arrangement to begin heating.

8. The aerosol provision device according to claim 7 and comprising an in progress inhale detection element, the in progress inhale detection element configured to:
detect a user drawing air from the aerosol provision device; and
in response to detecting the user drawing air from the aerosol provision device, send the in progress inhale signal to the controller.

9. The aerosol provision device according to claim 7, wherein the controller is configured to control the first heating arrangement to continue heating after receiving the in progress inhale signal.

10. The aerosol provision device according to claim 1, wherein the first heating arrangement is the external heating arrangement.

11. The aerosol provision device according to claim 1, wherein the first heating arrangement is the internal heating arrangement.

12. The aerosol provision device according to claim 1, wherein the internal heating arrangement comprises an elongate heating element and the external heating arrangement comprises a tubular body.

13. The aerosol provision device according to claim 1, wherein the external heating arrangement is configured to fully encircle the aerosol generating article.

14. The aerosol provision device according to claim 1, wherein the internal heating arrangement comprises a plurality of internal heating elements axially displaced along a length of the first heating arrangement

15. The aerosol provision device according to claim 14, wherein the external heating arrangement comprises a plurality of external heating elements axially displaced along a length of the second heating element.

16. The aerosol provision device according to claim 15, wherein at least one of the external heating elements is axially aligned with a respective internal heating element.

17. The aerosol provision device according to claim 1, wherein at least one of the internal heating arrangement and the external heating arrangement comprises at least one of a resistive heating arrangement and an inductive heating arrangement.

18. The aerosol provision device according to claim 1 and comprising a housing which houses at least one electrical component of the device, wherein the internal heating arrangement and the external heating arrangement extend from the housing.

19. The aerosol provision system comprising the aerosol provision device of claim 1 and an article comprising aerosol generating material.

20. A method of operating an aerosol provision device for generating an aerosol from an article comprising aerosol generating material, the aerosol provision device comprising an internal heating arrangement and an external heating arrangement, wherein at least a portion of the internal heating arrangement is arranged to extend into the article to heat the aerosol generating material and at least a portion of the external heating arrangement is arranged to extend at least partly around the article to heat the aerosol generating material, the method comprising:
receiving a pre-inhale signal indicating that a user is about to draw from the aerosol provision device; and
in response to receiving the pre-inhale signal, control one of the internal heating arrangement and the external heating arrangement to begin heating.
